(19) United States
(12) Patent Application Publication
(10) Pub. No.: US 2015/0199190 A1
(43) Pub. Date: Jul. 16, 2015

(54) SYSTEM AND METHOD FOR UPDATING FIRMWARE

(71) Applicant: Google Inc., Mountain View, CA (US)

(72) Inventors: Randall R. SPANGLER, San Jose, CA (US); Stefan Reinauer, Mountain View, CA (US)

(73) Assignee: Google Inc., Mountain View, CA (US)

(21) Appl. No.: 13/691,649

(22) Filed: Nov. 30, 2012

Related U.S. Application Data
(60) Provisional application No. 61/602,568, filed on Feb. 23, 2012.

(51) Int. Cl. G06F 9/445

(52) U.S. Cl. CPC G06F 8/65; G06F 9/4401

(57) ABSTRACT

A computer-implemented method for updating firmware in a computer is disclosed according to an aspect of the subject technology. The method comprises writing new firmware to a non-volatile memory of the computer and setting a boot count to a non-zero value. The method also comprises a) decrementing the boot count and b) attempting to boot the computer using the new firmware in the non-volatile memory. The method further comprises, if the computer fails to boot using the new firmware and the boot count is greater than zero, then repeating steps a) and b).

### CROSS-REFERENCE TO RELATED APPLICATIONS

The present application claims the benefit of U.S. Provisional Patent Application Ser. No. 61/602,568, entitled “System and Method for Updating Firmware,” filed on Feb. 23, 2012, which is hereby incorporated by reference in its entirety for all purposes.

### FIELD

The subject disclosure generally relates to computers, and, in particular, to updating firmware in computers.

### BACKGROUND

A computer (e.g., laptop computer) may include a processor and a non-volatile memory for storing firmware and information about the computer. When the computer is first powered on, the processor may execute the firmware in the non-volatile memory to boot the computer. The non-volatile memory may comprise electrically erasable/programmable read-only memory (EEPROM) and/or other type of non-volatile memory. The firmware in the non-volatile memory may need to be updated, for example, when a new version of the firmware becomes available.

### SUMMARY

A computer-implemented method for updating firmware in a computer is disclosed according to an aspect of the subject technology. The method comprises writing new firmware to a non-volatile memory of the computer and setting a boot count to a non-zero value. The method also comprises a) decrementing the boot count and b) attempting to boot the computer using the new firmware in the non-volatile memory. The method further comprises, if the computer fails to boot using the new firmware and the boot count is greater than zero, then repeating steps a) and b).

A machine-readable medium is disclosed according to an aspect of the subject technology. The machine-readable medium comprises instructions stored therein, which when executed by a machine, cause the machine to perform operations for updating firmware in a computer. The operations comprise writing new firmware to a non-volatile memory of the computer and setting a boot count to a non-zero value. The operations also comprise a) decrementing the boot count and b) attempting to boot the computer using the new firmware in the non-volatile memory. The operations further comprise, if the computer fails to boot using the new firmware and the boot count is greater than zero, then repeating steps a) and b), and, if the computer fails to successfully boot using the new firmware and the boot count is zero, then attempting to boot the computer using old firmware in the non-volatile memory.

A system for updating firmware in a computer is disclosed according to an aspect of the subject technology. The system comprises one or more processors, and a machine-readable medium comprising instructions stored therein, which when executed by the one or more processors, cause the one or more processors to perform operations. The operations comprise setting an update count to a non-zero value, and, after the computer is rebooted, performing steps. The steps comprise a) decrementing the update count and b) attempting to write new firmware to a non-volatile memory of the computer. The operations also comprise, if the computer fails to successfully write the new firmware and the update count is greater than zero, then repeating steps a) and b), and, if the computer successfully writes the new firmware, then rebooting the computer using the new firmware.

It is understood that other configurations of the subject technology will become readily apparent to those skilled in the art from the following detailed description, wherein various configurations of the subject technology are shown and described by way of illustration. As will be realized, the subject technology is capable of other and different configurations and its several details are capable of modification in various other respects, all without departing from the scope of the subject technology. Accordingly, the drawings and detailed description are to be regarded as illustrative in nature and not as restrictive.

### BRIEF DESCRIPTION OF THE DRAWINGS

The accompanying drawings, which are included to provide further understanding of the subject technology and are incorporated in and constitute a part of this specification, illustrate aspects of the subject technology and together with the description serve to explain the principles of the subject technology. In the drawings:

FIG. 1 is a conceptual block diagram of a computer according to an aspect of the subject technology.

FIG. 2 shows a non-volatile memory according to an aspect of the subject technology.

FIG. 3 shows a method for updating firmware according to an aspect of the subject technology.

FIG. 4 shows a method for updating firmware according to another aspect of the subject technology.

FIG. 5 is a conceptual block diagram of an embedded controller according to an aspect of the subject technology.

FIG. 6 shows a method for updating firmware in the embedded controller according to an aspect of the subject technology.

FIG. 7 shows a method for updating firmware at startup according to an aspect of the subject technology.

FIG. 8 shows a method that may be performed after a successful boot according to an aspect of the subject technology.

FIG. 9 shows a method for updating firmware according to another aspect of the subject technology.

FIG. 10 shows a method for recovering a computer according to an aspect of the subject technology.

### DETAILED DESCRIPTION

The detailed description set forth below is intended as a description of various configurations of the subject technology and is not intended to represent the only configurations in which the subject technology may be practiced. The appended drawings are incorporated herein and constitute a part of the detailed description. The detailed description includes specific details for the purpose of providing a thorough understanding of the subject technology. However, it will be clear and apparent to those skilled in the art that the subject technology is not limited to the specific details set forth herein and may be practiced without these specific details. In some instances, well-known structures and components are shown in block diagram form in order to avoid obscuring the concepts of the subject technology.

A computer (e.g., laptop computer) may include a non-volatile memory (e.g., EEPROM) for storing firmware and information about the computer. For example, the computer may store two copies of writable firmware (updateable firmware) in separate sections of the non-volatile memory, which may be designated RW_Section A and RW_Section B.

During a normal boot, the computer may boot using the writable firmware in RW_Section A. If the computer is unable to properly boot using the writable firmware in RW_Section A, then the computer may boot using the writable firmware in RW_Section B. If the computer is unable to boot using either copy of the writable firmware, then the computer may go into recovery mode, in which two new copies of writable firmware are written to RW_Section A and RW_Section B to return the computer to a known and trusted state.

Occasionally, the writable firmware needs to be updated. To accomplish this, an update program may write a copy of new firmware to RW_Section B and set a flag instructing the computer to boot using the new firmware in RW_Section B on the next boot cycle. If the computer successfully boots using the new firmware in RW_Section B, then a copy of the new firmware is written to RW_Section A so that both copies of the writable firmware in the non-volatile memory are updated. However, if the computer is accidently shut down during the boot process or is otherwise prevented from completing the boot process, then the computer may incorrectly infer that the new firmware failed and fallback to the old firmware in RW_Section A. In this case, the update may fail even though there may be nothing wrong with the new firmware.

To address this, systems and methods according to various aspects of the subject technology provide a boot count that specifies a number of boot attempts using the firmware in RW_Section B. When the boot count is zero, the computer boots using the firmware in RW_Section A. When the boot count is non-zero, the computer decrements the boot count and boots using the firmware in RW_Section B. If the boot is successful, then the boot count may be cleared. If the boot is unsuccessful, then the computer may make one or more additional attempts to boot the computing using the firmware in RW_Section B, assuming the boot count is still non-zero. For each boot attempt, the computer may decrement the boot count. The computer may repeat this process until the computer successfully boots using the firmware in RW_Section B or until the boot count reaches zero after exhausting all of the boot attempts specified by the initial value of the boot count.

In one aspect, when an update program writes new firmware to RW_Section B, the update program may set the boot count to a non-zero value (e.g., six) greater than one. In this aspect, the computer may make more than one attempt to boot the computer using the new firmware in RW_Section B before giving up and falling back to the old firmware in RW_Section A. An advantage of the boot count is that, if the computer is accidently shut down during a boot process or is otherwise prevented from completing the boot process, then the computer may make another boot attempt using the new firmware in RW_Section B, thereby increasing the reliability of the firmware update.

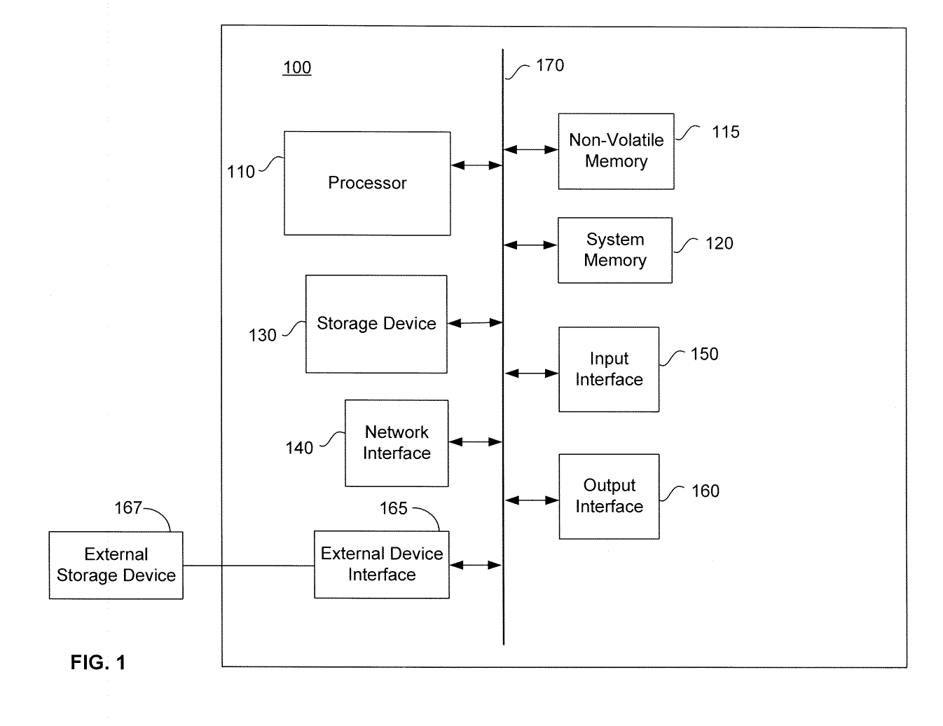

FIG. 1 shows a computer 100 according to an aspect of the subject technology. The computer may 100 be a laptop computer, a desktop computer, a tablet, a smart phone, or other type of computer. While the computer 100 is shown in one configuration in FIG. 1, it is to be understood that the computer may include additional, alternative and/or fewer devices.

In the example shown in FIG. 1, the computer 100 includes a processor 110, a non-volatile memory 115, a system memory 120, an internal storage device 130, a network interface 140, an input interface 150, an output interface 160, an external device interface 165, and a bus 170. The bus 170 collectively represents all system, peripheral, and chipset buses that communicatively connect the numerous devices of the computer 100. For instance, the bus 170 communicatively connects the processor 110 with the non-volatile memory 115, the system memory 120, and the internal storage device 130. The processor 110 may retrieve instructions from one or more of these memories 115, 120, and 130 and execute the instructions to implement processes according to various aspects of the subject technology. The processor 110 may comprise a single processor or a multi-core processor in different implementations.

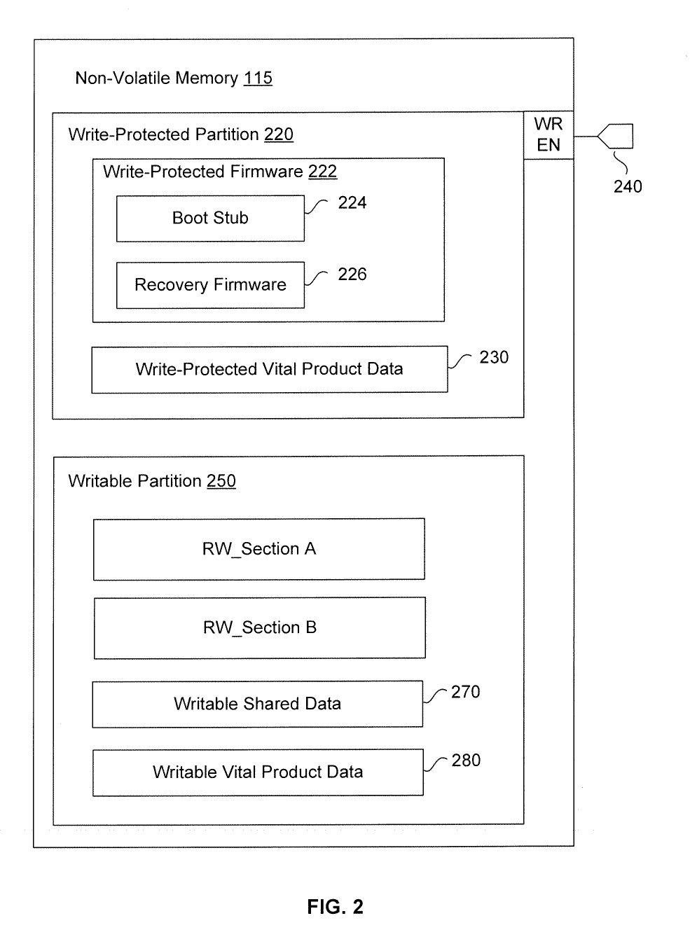

The non-volatile memory 115 may comprise an electrically erasable programmable read-only memory (EEPROM), an embedded multimedia card (e-MMC), a NOR Flash, a NAND Flash, battery-backed RAM, and/or other type of non-volatile memory. The non-volatile memory 115 may be used to store firmware for booting the computer 100 and information about the computer 100. The non-volatile memory 115 is discussed in greater detail below with reference to FIG. 2 according to an aspect of the subject technology.

The internal storage device 130 comprises a read-and-write memory that can store information when the computer 100 is turned off, such as a solid state drive, a magnetic disk drive, or an optical drive. The storage device 130 may be used to store an operating system (OS), programs, and/or files. The system memory 120 comprises a volatile read-and-write memory, such a random access memory. The system memory 120 may be used to store instructions and data that the processor 110 needs at runtime.

The network interface 140 enables the computer 100 to communicate with a network, for example, a local area network (LAN), a wide area network (WAN), an Intranet, the Internet. The network interface 140 may include a wireless communication module for communicating with the network over a wireless link (e.g., a WiFi wireless link, cellular link, etc.).

The input interface 150 enables a user to communicate information and commands to the computer 100. For example, the input interface 150 may be coupled to an alphanumeric keyboard and/or a pointing device (e.g., touch pad or mouse). In another example, the input interface 150 may be coupled to a touch screen that receives commands from the user by detecting the presence and location of a user's finger or stylus on the touch screen.

The output interface 160 may be used to communicate information to the user. For example, the output interface 160 may be coupled to a display (e.g., liquid crystal display (LCD)) and/or a printer.

The external device interface 165 enables the processor 110 to communicate with an external storage device 167 and/or other external device. For example, the external storage device 167 may be coupled to the external device interface 165 via a physical link (e.g., a universal serial bus (USB) link) and/or a wireless link (e.g., a WiFi wireless link, a Bluetooth link, etc.). The external storage device 167 may be a USB drive or a secure digital (SD) card, and the interface 165 may be a USB port or a SD card reader, respectively.

FIG. 2 is a conceptual block diagram of the non-volatile memory 115 according to an aspect of the subject technology. The non-volatile memory 115 comprises a write-protected partition 220 and a writable partition 250. The non-volatile memory 115 may be configured to allow the processor 110 to read content in the write-protected partition 220, but not to erase and rewrite content in the write-protected partition 220 when write protection is enabled, as discussed further below. The write-protected partition 220 may be used to protect system critical firmware (e.g., write-protected firmware) and data from being rewritten by an attacker. The non-volatile memory 115 may be configured to allow the processor 110 to read and write content in the writable partition 250. The writable partition 250 may be used to store content that may be updated (e.g., writable firmware).

In one aspect, the non-volatile memory 115 may include a write-enable pin 240 or write-protection pin that controls whether content in the write-protected partition 220 can be rewritten. For example, the write-enable pin 240 may be pulled up to allow writes to the write-protected partition 220 and pulled down to prevent writes to the write-protected partition 220.

In this aspect, content (i.e., write-protected firmware) may be written to the write-protected partition 220 during manufacturing of the computer 100. Before the computer 100 is shipped from the manufacturer, the write-enable pin 240 or write-protection pin may be set to prevent the content in the write-protected partition 220 from being rewritten (e.g., by an attacker). For example, the write-enable pin 240 may be pulled down by internal circuitry (not shown) in the computer 100 to prevent the content in the write-protected partition 220 from being rewritten. As a result, content in the write-protected partition 220 cannot be easily rewritten by an attacker without physical access to the internal circuitry of the computer 100. The write-protected partition 220 may be write protected by another write-protection mechanism, such as a write-protection mechanism without a write-enable or write-protection pin (e.g., depending on the type of non-volatile memory used). Thus, the write-protected partition 220 may be writable during manufacturing and write-protected (i.e., read only) after manufacturing.

The write-protected partition 220 may include write-protected firmware 222 and write-protected vital product data 230. The write-protected vital product data 230 may include machine-specific information that is to remain fixed, such as manufacturer of the computer 100, mother board serial number, MAC address, and/or other information. The write-protected firmware 222 may include a boot stub 224 and recovery firmware 226. The boot stub 224 may be configured to initiate a boot process of the computer 100 when executed by the processor 110 and the recovery firmware 226 may be configured to perform a recovery process when executed by the processor 110 to restore the computer 100 to a known and trusted state, as discussed further below.

The writable partition 250 may include two copies of writable firmware stored in separate writable sections, which may be designated read-write (RW)_Section A and RW_Section B. The writable firmware in each section may be configured to complete the boot process initiated by the boot stub 224 when executed by the processor 110. The boot process may include detecting devices in the computer 100 and running verification tests. The boot process may also include loading an OS into the system memory 120 (e.g., RAM memory) from the storage device 130 or other memory, and executing the OS. In one aspect, the boot process may include verifying that the OS is digitally signed by a trusted supplier and only executing the OS after successful verification, as discussed further below. Each copy of the writable firmware may be updated after shipment from the manufacturer by an update program, for example, when an update to the writeable firmware becomes available on a network. Firmware update processes according to various aspects of the subject technology are discussed below.

The writable partition 250 may also include writable shared data 270 that may be shared by the writable firmware in RW_Section A and RW_Section B. The writable shared data 270 may include memory timing information for the system memory 120 (e.g., RAM), cache memory and/or other memory, and/or developer mode configuration data. The memory timing information may include column access strobe (CAS) time, row access strobe (RAS) time, row precharge time and/or other memory timing information. The memory timing information may be formatted according to a serial presence detect (SPD) standard by the joint electron devices engineering council (JEDEC) or other standard. During boot time, the writable firmware in RW_Section A and RW_Section B may be configured to load the memory timing information from the non-volatile memory 115 to a memory controller (not shown) so that the processor 110 can access the system memory 120 (e.g., RAM) and/or other memory.

The writable partition 250 may also include writable vital product data 280, which may be updated and/or generated after the computer 100 is shipped from the manufacturer. For example, writable vital product data may include the date and time that the computer 100 is first used by a user. This information may be used to determine whether the computer 100 is still under a warranty that runs from the first time the user uses the computer 100. The writable vital product data may also include an event log for logging system-critical events that may occur during runtime, including the occurrence of events which caused or lead up to a catastrophic failure.

In one aspect, the boot stub 224 is configured to select the writable firmware in RW_Section A or RW_Section B for booting the computer 100 based on a boot count. The boot stub 224 may be configured to select the writable firmware in RW_Section A when the boot count is zero and select the writable firmware in RW_Section B when the boot count is non-zero. As discussed further below, the value of the boot count specifies a number of boot attempts using the writable firmware in RW_Section B. The boot count may be stored in the non-volatile memory 115 or other memory.

After selecting the writable firmware in RW_Section A or RW_Section B, the boot stub 224 may verify that the selected writable firmware is digitally signed by a trusted supplier (e.g., using a cryptographic key) before allowing the processor 110 to execute the selected writable firmware. For example, the writable firmware in RW_Section A and RW_Section B may each be digitally signed by the trusted supplier using a private key and the boot stub 224 may use a corresponding public key to verify the digital signature of the selected writable firmware.

If the computer 100 fails to boot using the selected writable firmware (e.g., the boot stub 224 is unable to verify the selected writable firmware), then the boot stub 224 may attempt to boot the computer 100 using the other writable firmware. If the computer 100 fails to properly boot using the writable firmware in both RW_Section A and RW_Section B, then the boot stub 224 may execute the recovery firmware 226 to restore the computer 100 to a known and trusted state, as discussed further below.

When there are no firmware updates, the boot count is zero, and the boot stub 224 boots the computer 100 using the writable firmware in RW_Section A. If the computer 100 fails to boot using the writable firmware in RW_Section A, then the boot stub 224 may attempt to boot the computer 100 using the writable firmware in RW_Section B. This may occur, for example, when the writable firmware in RW_Section A becomes corrupted. Thus, the writable firmware in RW_Section B may be used as a fall back in case the computer 100 is unable to boot using the writable firmware in RW_Section A.

If the computer 100 is able to boot using the writable firmware in RW_Section B after failing to boot using the writable firmware in RW_Section A, then the boot stub 224 or other firmware may set an indicator indicating that the computer 100 booted using the firmware in RW_Section B. In this case, the OS may determine that the computer 100 was booted from RW_Section B based on the indicator and write a new copy of the writable firmware to RW_Section A to repair the writable firmware in RW_Section A. The new copy of the writable firmware may be written from RW_Section B, the system memory, the internal memory device or other memory.

A procedure for updating the writable firmware in the non-volatile memory 115 according to aspect of the subject technology will now be discussed.

In one aspect, the writable firmware in RW_Section A and RW_Section B may each include version information indicating a version of the firmware. In this aspect, an update program may periodically check a server on a network to determine whether a new version of the writable firmware is available on the network. For example, the update program may send the version information for the writable firmware in RW_Section A and/or RW_Section B to the server via the network interface 140, and the server may compare the version information to the latest version of the writable firmware available on the network to determine whether the latest version available on the network is newer. If new writable firmware is available, then the server may send a message to the computer 100 indicating that a new version of the firmware is available. Alternatively, the server may send information to the computer about the latest version of the writable firmware on the network and the program may compare the received information to the version information to determine whether a firmware update is available.

If a firmware update is available, then the update program may download the new writable firmware to one of the memories 120 and 130. The update program may then write the new writable firmware to RW_Section B. This may involve erasing the old writable firmware from RW_Section B and then writing the new writable firmware to RW_Section B. The update program may also set the boot count to a non-zero value so that the boot stub 224 attempts to boot the computer 100 using the new writable firmware in RW_Section B on the next boot cycle. The update program may set the boot count to a non-zero value greater than one (e.g., six) so that the boot stub 224 can make more than one attempt to boot the computer 100 using the new writable firmware in RW_Section B if needed.

On the next boot cycle, the boot stub 224 checks the value of the boot count. Because the boot count is non-zero, the boot stubs 224 attempts to boot the computer 100 using the new writable firmware in RW_Section B. The boot stub 224 may also decrement the boot count by one since one of the boot attempts specified by the value of the boot count is being used up.

If the computer 100 successfully boots using the new writable firmware, then the update program may clear the boot count (i.e., set boot count to zero) and copy the new writable firmware to RW_Section A. This may involve erasing the old writable firmware from RW_Section A and then writing the new writable firmware to RW_Section A. As a result, two copies of the new writable firmware reside in the non-volatile memory 115. Thereafter, the boot stub 224 may normally boot the computer 100 using the new writable firmware in RW_Section A since the boot count is zero, and use the new writable firmware in RW_Section B as a fall back.

If the computer 100 fails to boot using the new writable firmware in RW_Section B, then the boot stub 224 may make one or more additional attempts to boot the computer 100 using the new writable firmware in RW_Section B, assuming the boot count is still non-zero. For each boot attempt using the new writable firmware in RW_Section B, the boot stub 224 may decrement the boot count by one. The boot stub 224 may repeat this process until the computer 100 successfully boots using the new writable firmware in RW_Section B, in which case the boot count is cleared, or until the count value reaches zero after exhausting all of the boot attempts specified by the initial value of the boot count, in which case the boot stub 224 gives up trying to boot the computer 100 using the new writable firmware in RW_Section B.

If the computer 100 fails to boot using the new writable firmware in RW_Section B after exhausting all of the attempts specified by the initial value (e.g., six) of the boot count, then the boot stub 224 may boot the computer 100 using the old writable firmware in RW_Section A. In this case, the boot stub 224 may notify the update program that the computer 100 failed to boot using the new writable firmware. In response, the update program may write the old version of the writable firmware back to RW_Section B, in which case the update fails.

If the computer 100 successfully boots using the new writable firmware in RW_Section B, then the update program may write a copy of the new writable firmware in RW_Section A and clear the boot count so that the boot stub 224 boots the computer 100 using the new writable firmware in RW_Section A on the next boot cycle. Thus, the new writable is not committed to RW_Section A until the computer 100 successfully boots using the new writable firmware in RW_Section B.

An advantage of the boot count is that, if the computer 100 is accidently shut down during an attempt to boot the computer 100 using the new writable firmware in RW_Section B or is otherwise prevented from completing the boot process, then the boot stub 224 makes another attempt to boot the computer 100 using the new writable firmware before giving up (assuming the boot count is initially greater than one). Thus, the firmware update does not fail due to a single failed attempt to boot the computer 100 using the writable firmware in RW_Section B. This increases the reliability of the firmware update.

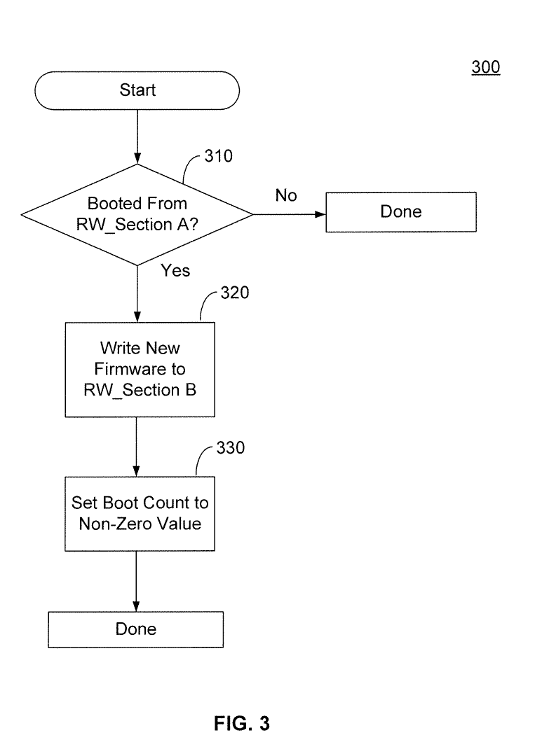

FIG. 3 shows a method 300 for updating writable firmware according to an aspect of the subject technology. The method 300 may be performed by the update program when a new version of the writable firmware is available.

In step 310, a determination is made whether the computer 100 booted from RW_Section A. If the computer 100 did not boot from RW_Section A (i.e., booted from RW_Section B), then the method 300 is done. This may occur, for example, when the writable firmware in RW_Section A is corrupted, leaving the non-volatile memory 115 with only one good copy of writable firmware in RW_Section B. In this case, the update program may write a copy of the old writable firmware in RW_Section A to repair the writable firmware in RW_Section A. If the computer 100 successfully boots from RW_Section A on the next boot cycle, then the method 300 may be repeated.

If the computer 100 booted from RW_Section A, then the method 300 proceeds to step 320. In step 320, the new version of the writable firmware is written to RW_Section B. In step 330, the boot count is set to a non-zero value so that the boot stub 224 attempts to boot the computer 100 using the new writable firmware in RW_Section B on the next boot cycle. The non-zero value may be selected based on a desired number of boot attempts using the new writable firmware in RW_Section B.

After the new writable firmware is written to RW_Section B, the computer 100 may be immediately rebooted or may be rebooted after the user shuts down the computer 100 and turns the computer 100 back on.

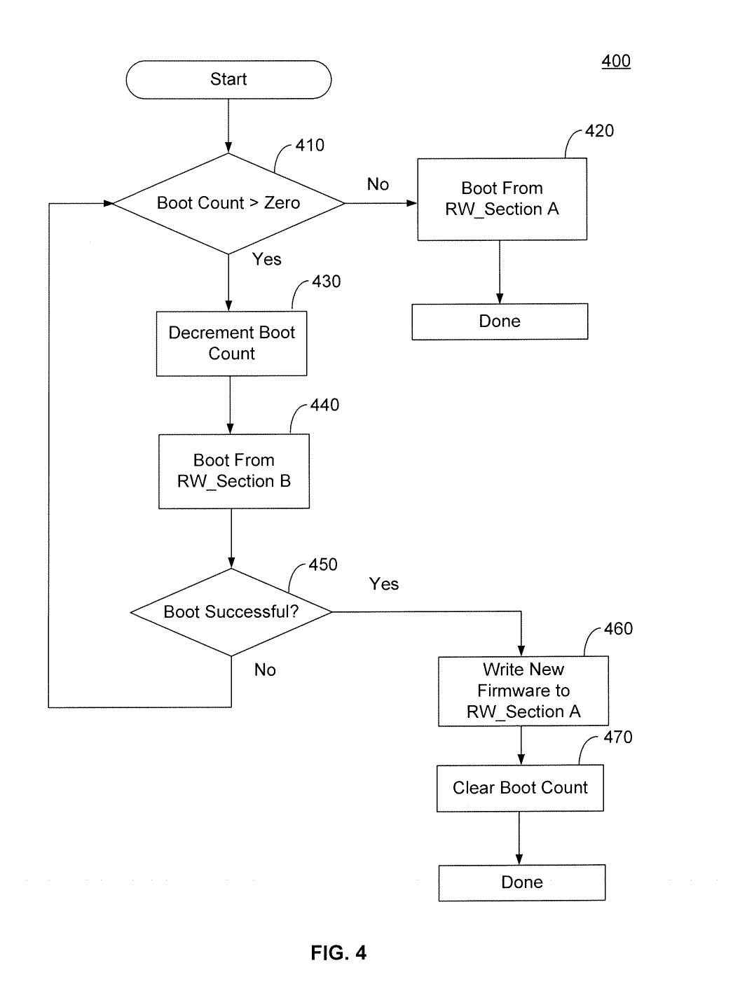

FIG. 4 shows a method 400 for updating the firmware in RW_Section A according to an aspect of the subject technology. The method 400 may be performed after the new writable firmware has been written to RW_Section B using the method 300 in FIG. 3 and the computer 100 has been rebooted.

In step 410, the boot stub 224 determines whether the boot count is greater than zero. If the boot count is equal to zero, then the boot stub 224 may boot the computer 100 using the writable firmware in RW_Section A in step 420.

If the boot count is greater than zero (i.e., boot count is non-zero), then the boot stub 224 decrements the boot count by one. In step 440, the boot stub 224 may boot the computer 100 using the new writable firmware in RW_Section B. If the computer 100 does not successfully boot using the new writable firmware in step 450, then the method 400 returns to step 410. This may occur, for example, when the computer 100 is accidently shut off before the computer 100 is able to complete the boot process or is otherwise prevented from completing the boot process. If the boot count is still greater than zero, then the boot stub 224 makes another attempt to boot the computer 100 using the new writable firmware in RW_Section B.

If the computer 100 successfully boots using the new writable firmware in step 450, then the method 400 proceeds to step 460. In step 460, a copy of the new writable firmware is written to RW_Section A. As a result two copies of the new writable firmware now reside in the non-volatile memory 115. In step 470, the boot count is cleared (i.e., set to zero). If the boot count is already zero, then the boot count may be left alone. Since the boot count is cleared, the boot stub 224 boots the computer 100 using the new writable firmware in RW_Section A on the next boot cycle. The new writable firmware in RW_Section B is used as a fallback in case the computer 100 fails to boot using the new writable firmware in RW_Section A.

Thus, various aspects of the subject technology provide a two-stage process for updating the writable firmware in RW_Section A and RW_Section B, in which the new writable firmware is written to RW_Section B first. If the computer 100 is able to boot using the new writable in RW_Section B within the number of boot attempts specified by the initial value of the count value, then the new writable firmware is written to RW_Section A.

As discussed above, the computer 100 may enter recovery mode, in which the recovery firmware 226 may write two new copies of writable firmware to RW_Section A and RW_Section B from the external storage device 167, the internal storage device 130 or other memory. The boot stub 224 may initiate recovery mode, for example, when the computer fails to boot using the writable firmware in both RW_Section A and RW_Section B. Alternatively, the user may trigger recovery mode to return the computer to a factory default state.

While repairing the writable firmware in RW_Section A and RW_Section B, the recovery mode may leave the writable shared data 270 alone. As a result, a problem may occur when the writable shared data 270 is corrupted. For example, if the memory timing information in the writable shared data 270 is corrupted, then the processor 110 may not be able to properly program the memory controller during boot time, and therefore may not be able to access the system memory 120 and/or other memory.

To address this problem, systems and methods according to various aspects of the subject technology also repair the writable shared data 270 in the recovery mode. As part of the recovery process, the recovery firmware 226 may write a new copy of writable shared data 270 to the non-volatile memory 115 from the external storage device 167, the internal storage device 130 or other memory.

In one aspect, a recovery image including a copy of writable firmware and writable shared data may be stored in the external storage device 167, the internal storage device 130 or other memory. As part of the recovery process, the recovery firmware 226 may copy the writable firmware in the recovery image to both RW_Section A and RW_Section B of the non-volatile memory 115. The recovery firmware 226 may also copy the writable shared data in the recovery image to the non-volatile memory 115. This may involve erasing the old copy of the writable shared data 270 from the non-volatile memory 115 and then writing the new copy of the writable shared data 270 to the non-volatile memory 115.

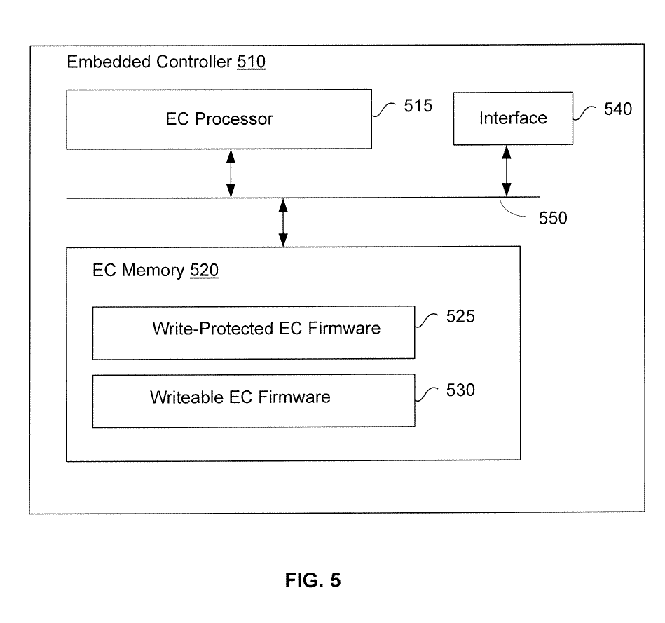

Referring to FIG. 5, the computer 100 may include an embedded controller 510. The embedded controller 510 may include an embedded controller (EC) processor 515, an embedded controller (EC) memory 520, an interface 540, and a bus 550. Bus 550 collectively represents all communication structures that communicatively connect the components of the embedded controller 510. The EC memory 520 may store firmware that is executed by the EC processor 515 to perform the operations of the embedded controller 510 described herein. The interface 540 may be configured to allow the EC processor 515 to communicate with the other devices of the computer 100 shown in FIG. 1 via bus 170.

In one aspect, the embedded controller 510 may be configured to control certain operations of the computer 100. For example, the embedded controller 510 may be configured to control the keyboard, light emitting diodes (LEDs) on the computer case, battery charging, and/or power to various devices on the computer 100. The embedded controller 510 may perform other operations in addition to or in the alternative to the operations listed above.

The embedded controller 510 may process signals from the keyboard to determine a state of the keyboard and communicate the state to the processor 110. For example, the embedded controller 510 may receive a keyboard matrix signal from the keyboard indicating the position (e.g., row and column) of a key pressed on the keyboard by the user. The embedded controller 170 may then identify the key (e.g., shift key, esc key, etc.) based on the position of the key and a keyboard layout stored in the EC memory 520. The embedded controller 510 may then communicate the identity of the key to the processor 110.

The EC memory 520 may comprise EEPROM and/or other type of non-volatile memory. As shown in FIG. 5, the EC memory 520 may store write-protected embedded controller (EC) firmware 525 that, when executed by the EC processor 515, performs one or more of the operations of the embedded controller 510 described herein. The write-protected EC firmware 525 may be write-protected by a hardware write-protection mechanism (e.g., write enable pin or write protection pin). In one aspect, the write-protected EC firmware may be written to the EC memory 520 during manufacturing. Before the computer 100 is shipped from the manufacturer, the write-protected EC firmware 525 may be write protected (e.g., by pulling down a write enable pin). This prevents the write-protected EC firmware 525 from being altered (e.g., by an attacker) after the computer 100 is shipped.

The EC memory 520 may also store writable embedded controller (EC) firmware 530 that, when executed by the EC processor 515, performs one or more of the operations of the embedded controller 510 described herein. The writable EC firmware 530 may be updated after the computer 100 is shipped from the manufacturer.

In one aspect, the EC processor 515 may first execute the write-protected EC firmware 525 during boot time. When executed by the EC processor 515, the write-protected EC firmware 525 may verify that the writable EC firmware 530 is not corrupted (e.g., using a cyclic redundancy check (CRC)) before allowing the EC processor to execute the writable EC firmware 530.

In one aspect, the write-protected EC firmware may also verify that the writable EC firmware 530 is digitally signed by a trusted supplier before allowing the EC processor 515 to execute the writable EC firmware 530. For example, the writable EC firmware 530 may be digitally signed by the trusted supplier using a private key and the write-protected EC firmware 525 may verify the digital signature of the writable EC firmware 530 using a corresponding public key.

If the write-protected EC firmware 525 successfully verifies the writable EC firmware 530, then the write-protected EC firmware 525 may allow the EC processor 515 to execute the writable EC firmware 530 to perform various operations of the embedded controller 510. If the write-protected EC firmware 525 is unable to verify the writable EC firmware 530, then the write-protected EC firmware 525 may direct the EC processor 515 to execute code in the write-protected EC firmware 525 to perform the various operations of the embedded controller 510.

A procedure for updating the writable EC firmware 530 according to aspect of the subject technology will now be discussed.

In one aspect, the writable EC firmware 530 may include version information indicating a version of the firmware. In this aspect, an update program may periodically check a server on a network to determine whether a new version of the writable EC firmware is available on the network.

If new writable EC firmware is available, then the update program may download the new EC writable firmware to one of the memories 120 and 130. The update program may then set a flag instructing the update program to update the writable EC firmware 530 in the EC memory 520 at the next startup when the computer is rebooted. The computer may be rebooted after the user shuts down the computer and turns the computer back on.

At the next startup, the update program may determine that the EC memory 520 needs to be updated based on the flag. At this time, the update program may write the new writable EC firmware 530 to the EC memory 520. This may involve erasing the old writable EC firmware from the EC memory 520 and then writing the new writable EC firmware 530 to the EC memory 520. After the writable EC firmware 530 is updated, the update program may immediately reboot the computer 100.

In one aspect, when an update of the writable EC firmware 530 is needed, the update program may specify a number of attempts to update the writable EC firmware 530 before giving up. The update program may do this by setting an update count to a non-zero value, in which the value of the update count specifies the number of update attempts. In this aspect, each time the update program attempts to update the writable EC firmware 530 at startup, the update program may decrement the update count. The update program may repeat this process until the writable EC firmware 530 is successfully updated or until the update count value reaches zero after exhausting all of the update attempts specified by the initial value of the update. When the writable EC firmware 530 is successfully updated, the update count may be cleared.

An advantage of the update count is that, if the user shuts down the computer in the middle of the update process or the computer is otherwise prevent from completing the update process, then the computer may retry the update before giving up.

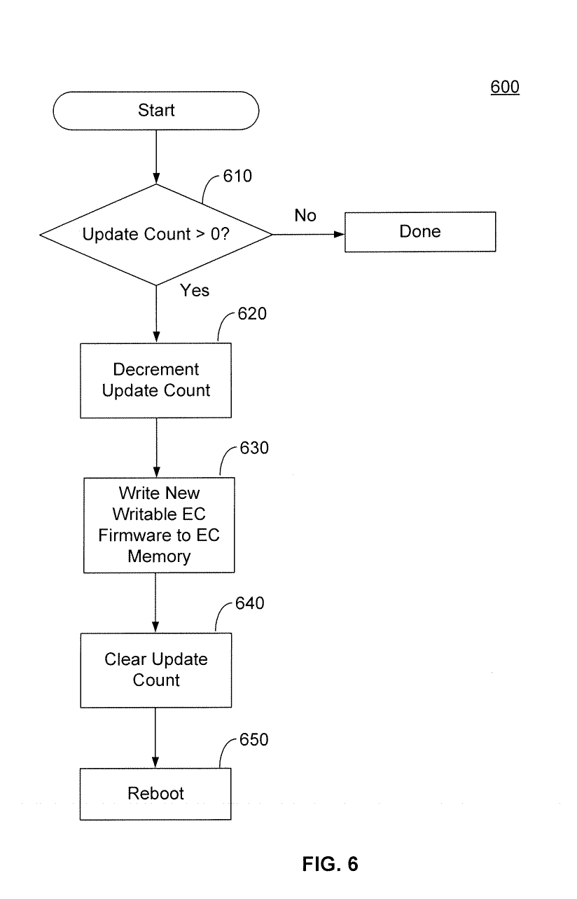

FIG. 6 shows a method 600 for updating the writable EC firmware 530 according to an aspect of the subject technology. The method 600 may be performed at startup shortly after the OS starts executing. In one aspect, the update program may have previously set the update count to a non-zero value indicating a number of update attempts.

In step 610, a determination is made whether the update count is greater than zero. If the update count is not greater than zero, then the method 600 is done. If the update count is greater than zero, then the method 600 proceeds to step 620.

In step 620, the update count is decremented by one. In step 630, the new writable EC firmware 530 is written to the EC memory 520. In step 640, the update count is cleared (i.e., set to zero). Step 640 is performed after the new writable EC firmware 530 is successfully written to the EC memory 520 in step 630. Finally, in step 650, the computer 100 is rebooted. When the computer 100 is rebooted, the EC processor 515 boots the embedded controller 510 using the new writable EC firmware 530.

If the computer 100 is accidently shut down while the new writable EC firmware 530 is being written to the EC memory 520 in step 630 or the computer 100 is otherwise prevented from completing the write operation, then the method 600 may be repeated at the next startup. If the update count is still non-zero, then another attempt to update the writable EC firmware 530 is made.

In one aspect, the computer 100 may operate in a normal mode and in a developer mode. In the normal mode, the computer 100 performs a verification process during boot to verify that the computer 100 only runs an official operating system (OS) from a trusted supplier. In the developer mode, the computer 100 may run an OS other than an official OS (e.g., an unsigned or self-signed OS). This allows a software developer to build and run its own code on the computer. A user may enable the developer mode by switching a physical developer switch on or holding down one or more keys on a keyboard during boot time.

In one aspect, different types of writable firmware may be provided to support normal mode and developer mode operations according to various aspects of the subject technology. One type of writable firmware may be referred to as normal firmware and another type of writable firmware may be referred to as developer firmware.

The normal firmware may be used to boot the computer in the normal mode. The normal firmware may only load an officially-signed OS regardless of whether the developer mode is enabled (e.g., ignores the state of the developer switch). Therefore, the normal firmware does not require code to check whether the developer mode is enabled (e.g., check the state of the developer switch).

The developer firmware may be used to boot the computer in the developer mode. The computer may only execute the developer firmware when the developer mode is enabled (e.g., the developer switch is on). Additionally, the developer firmware may run an internal check to verify that the developer mode is enabled before allowing the computer to continue to boot in developer mode. Further, the developer firmware may display a warning message alerting the user that the computer is booting in developer mode. The developer firmware may allow the computer to load an unsigned or self-signed OS, as discussed further below.

In one aspect, the computer 100 may be shipped from the manufacturer with the developer mode disabled (e.g., developer switch off) and two copies of the normal firmware in RW_Section A and RW_Section B. Thus, the computer 100 initially operates in the normal mode. The normal firmware in RW_Section A and RW_Section B may be updated using any of the firmware update processes discussed above.

To transition the computer 100 from normal mode to developer mode, the user may enable developer mode (e.g., by switching the developer switch on). A copy of developer firmware may then be written to RW_Section A while leaving a copy of the normal firmware in RW_Section B. To protect personal user information, a stateful partition comprising the personal user information may be wiped before the developer firmware in written to RW_Section A.

After the developer firmware is installed in RW_Section A, the boot stub 224 may boot the computer 100 in the developer mode using the developer firmware in RW_Section A. The boot stub 224 may verify that the developer mode is enabled (e.g., the developer switch is on) before executing the developer firmware. If the developer mode is disabled (e.g., user switched the developer switch off), then the boot stub 224 may boot the computer 100 in the normal mode using the normal firmware in RW_Section B. If the computer 100 is unable to boot using the normal firmware (e.g., because an officially-signed OS no longer resides in the storage device 130), then the boot stub 224 may initiate recovery to restore the computer to a known and trusted state. The recover process may include writing two copies of normal firmware to RW_Section A and RW_Section B.

In one aspect, the update program may determine whether an update of the developer firmware is available on the network. For example, the developer firmware in the RW_Section A may include version information identifying the version of the developer firmware. The update program may send the version information to a server via the network interface 140, and the server may look at the version information to determine whether a newer version of the developer firmware is available.

If new developer firmware is available, then the server may send a message to the computer 100 indicating that a new version of the firmware is available. The update program may then download the new developer firmware to one of the memories 120 and 130.

The update program may then display an update message alerting the user that an update of the developer firmware is available. Upon viewing the update message, the user may manually update the developer firmware by entering commands from a root shell to write the new developer firmware to RW_Section A. The update message may include instructions instructing the user how to manually update the developer firmware. Thus, the program may alert the user that an update of the developer firmware is available and leave it up to the user to manually update the developer firmware in the non-volatile memory 115.

Alternatively, the program may automatically update the developer firmware. In one aspect, the program may first write the new developer firmware to RW_Section B and set the boot count to a non-zero value so that the boot stub 224 boots the computer 100 using the new developer firmware in RW_Section B on the next boot cycle.

At this point, the new developer firmware resides in RW_Section B and the old version developer firmware resides in RW_Section A. On reboot, the boot stub 224 attempts to boot the computer 100 using the new developer firmware in RW_Section B. The boot stub 224 may verify that the new developer firmware is properly signed and that the developer mode is enabled before executing the new developer firmware.

If the computer 100 successfully boots using the new developer firmware in RW_Section B, then the new developer firmware may be written to RW_Section A and the normal firmware may be written to RW_Section B. As a result, the new developer mode resides in RW_Section A and the normal firmware resides in RW_Section B. The normal firmware written to RW_Section B may be an old or new version of the normal firmware. For example, the update program may download both a new version of the developer firmware and a new version of the normal firmware from the network. In this example, the new version of the normal firmware may be written to RW_Section B.

If the boot stub 224 is unable to boot the computer 100 using the new developer firmware in RW_Section B after exhausting all of the boot attempts specified by the initial value of the boot count, then the boot stub 224 may boot the computer using the old developer firmware in RW_Section A. The normal firmware may then be written back to RW_Section B. In this case, the update to the developer firmware fails.

To transition the computer 100 from the developer mode back to the normal mode, the user may disable the developer mode (e.g., switch the developer switch off). When the computer reboots, the boot stub 224 is unable to verify the developer firmware in RW_Section A since the developer mode is disabled. As a result, the boot stub 224 boots the computer 100 using the normal firmware in RW_Section B. If a copy of the official-signed OS still resides in the storage device 130 or other memory, then the computer 100 may successfully boot in the normal mode. A copy of the normal firmware may then be written back to RW_Section A, at which point two copies of normal firmware reside in the non-volatile memory 115.

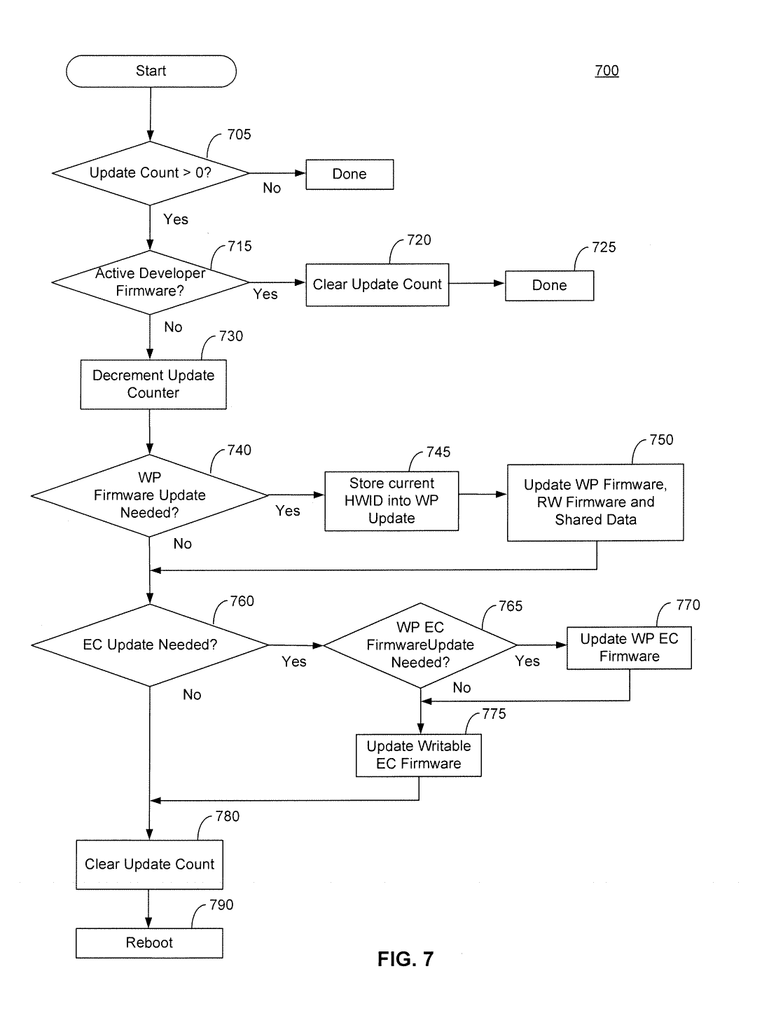

FIG. 7 shows a method 700 for updating firmware at startup, which occurs shortly after the OS starts executing. After the firmware update, the computer 100 may immediately reboot. The method 700 may be used to update firmware that may require that the computer 100 immediately reboot.

In step 705, a determination is made whether the update count is greater than zero. If the update count is equal to zero, then the method 700 is done.

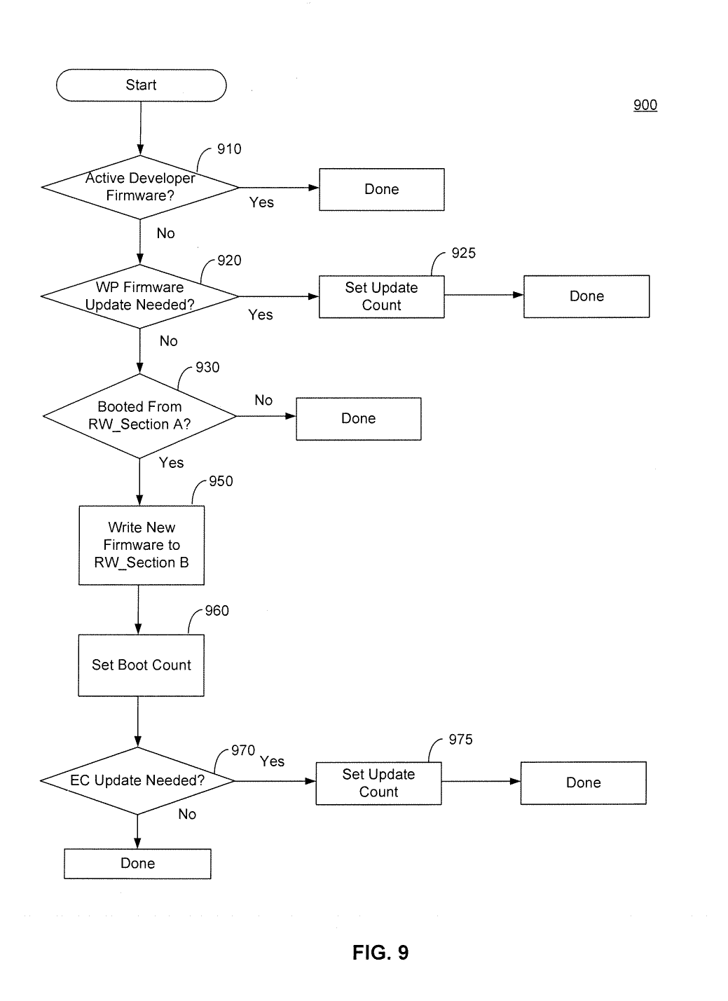

If the update count value is greater than zero, then the method 700 proceeds to step 715. As discussed further below, the update count may have previously been set to a non-zero value by the method shown in FIG. 9.

In step 715, a determination is made whether the computer has active developer firmware. Active developer firmware may mean that the firmware in RW_Section A is developer firmware and/or the computer 100 booted developer firmware. If the computer has active developer firmware, then the update count is cleared in step 720 and the method is done. This is because, in the developer mode, the user may be responsible for manually updating firmware.

If the computer does not have active developer firmware, then the method 700 proceeds to step 730. In step 730, the update count is decremented.

In step 740, a determination is made whether the write-protected firmware 222 needs to be updated. This determination may be made by comparing version information for the write-protected firmware 222 currently in the non-volatile memory 115 with version information for available write-protected firmware 222 (e.g., available from the storage device 130 or other memory or available from a network). If write protection is enabled on the non-volatile memory 115 (e.g., write enable pin is pulled down), then step 740 may be skipped and the method 700 may immediately proceed to step 760. Thus, step 740 may not apply to a computer 100 that has been shipped from the manufacturer since write protection may be enabled before shipment.

If an update of the write-protected firmware 222 is needed, then the method 700 proceeds to step 745. In step 745, a hardware identification (HWID) of the computer 100 is written to the write-protected partition 220 to preserve the HWID of the computer 100 across updates. In step 750, new write-protected firmware 222 is written to the write-protected partition 220. In addition, writable firmware and writable shared data that are compatible with the new write-protected firmware may be written to the writable partition 250 of the non-volatile memory 115 to ensure compatibility between the updated write-protected firmware and the writable firmware. After step 750, the method 700 proceeds to step 760. If an update of the write-protected firmware is not needed, then the method 700 may proceed directly to step 760.

In step 760, a determination is made whether the embedded controller 510 needs a firmware update. This determination may be made by comparing version information for the writable EC firmware 530 currently in the EC memory 520 with version information for available EC firmware (e.g., available from the storage device 130 or other memory or available from a network). If an update is needed, then the method 700 proceeds to step 765.

In step 765, a determination is made whether the write-protected EC firmware 525 needs to be updated. This determination may be made by comparing version information for the write-protected EC firmware 525 in the EC memory 520 with version information for available write-protected EC firmware 525 (e.g., available from the storage device 130 or other memory or available from a network). If the current write-protected EC firmware 525 is write protected, then step 765 may be skipped and the method 700 may immediately proceed to step 775. This is because, in this case, the current write-protected EC firmware 525 may not be rewritable and therefore can not be updated.

If the write-protected EC firmware 525 needs to be updated, then the write-protected EC firmware 525 in the EC memory 520 is updated in step 770. In step 775, the writable EC firmware 530 in the EC memory 520 is updated.

In step 780, the update count is cleared (i.e., set to zero) since the updates have been completed when this step is reached. In step 790, the computer 100 is rebooted.

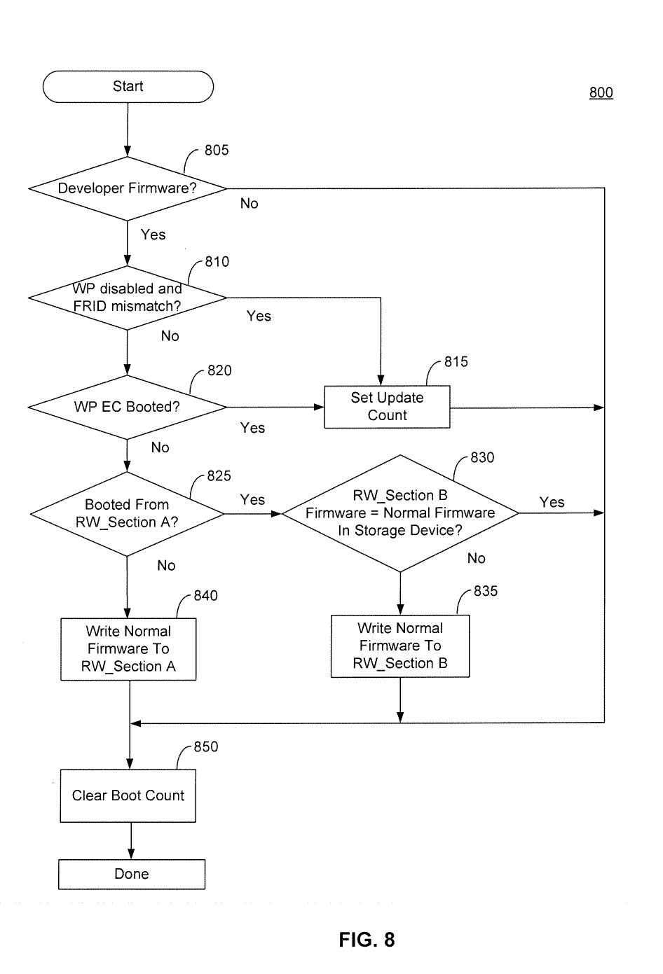

FIG. 8 shows a method 800 that may be performed after the computer 100 has successfully booted. For example, method 800 may be performed 30 to 60 seconds after the OS and writable firmware have booted successfully.

In step 805, a determination is made whether the firmware in RW_Section A is developer firmware. If the firmware in RW_Section A is developer firmware, then the method 800 proceeds to step 850. Otherwise, the method 800 proceeds to step 810.

In step 810, a determination is made whether write protection is disabled on the non-volatile memory 115 and a firmware identifier (FRID) of the write-protected firmware 222 does not match the FRID of the write-protected firmware available in the storage device 130 or other memory. The FRID indicates the version of the respective firmware. If write protection is disabled and the FRIDs do not match, then the method 800 proceeds to step 815. In step 815, the update count is set to a non-zero value so that the write-protected firmware is updated when method 700 is performed at the next startup. In one aspect, an indicator may be set to indicate that the write-protected firmware needs to be updated and the indicator may be checked in step 740 of the method 700 in FIG. 7 to determine whether the write-protected firmware needs to be updated. After the update count is set, the method 800 proceeds to step 850.

If write protection is enabled on the non-volatile memory or the FRID of the current write-protected firmware 222 matches the FRID of the available write-protected firmware, then the method proceeds to step 820.

In step 820, a determination is made whether the embedded controller 510 booted using the write-protected EC firmware 525. If the embedded controller 510 booted using the write protected EC firmware 525, then the method 700 proceeds to step 815. This may occur, for example, when the embedded controller failed to boot using the writable EC firmware 530. In this case, an indicator may be set to indicate that the writable EC firmware 530 in the EC memory 520 needs to be updated with a new copy of the writable EC firmware 530 to repair the writable EC firmware. The indicator may be checked in step 760 of the method 700 in FIG. 7 to determine whether the embedded controller needs a firmware update. In step 815, the update count is set to a non-zero value so that the writeable EC firmware 530 firmware is updated when method 700 is performed at the next startup. After the update count is set, the method 800 proceeds to step 850.

If the embedded controller 510 did not boot using the write-protected EC firmware, then the method 800 proceeds to step 825.

In step 825, a determination is made whether the computer 100 booted from RW_Section A. If the computer 100 booted from RW_Section A, then the method 800 proceeds to step 830. In step 830, a determination is made whether the normal firmware in RW_Section B matches normal firmware in the storage device 130 or other memory. This determination may be made by comparing version information for the normal firmware in RW_Section B with version information for the normal firmware in the storage device 130 or other memory. If the normal firmware in RW_Section B matches, then the method 800 proceeds to step 850. If the normal firmware in RW_Section B does not match the normal firmware in the storage device 130 or other memory, then the normal firmware in the storage device 130 or other memory may be written to RW_Section B to update the normal firmware in RW_Section B. This ensures that the firmware in RW_Section B provides a good backup for the firmware in RW_Section A.

If the computer 100 did not boot from RW_Section A (i.e., booted from RW_Section B), then the method proceeds to step 840. This may also occur when the firmware in RW_Section A is corrupted. This may also occur when the computer 100 successfully boots new firmware in RW_Section B as part of a two-stage update process, as discussed above. This may also occur when the computer 100 boots normal firmware in RW_Section B during a transition from developer mode to normal mode, as discussed above.

In step 840, normal firmware is written to RW_Section A from the storage device 130 or other memory.

In step 850, the boot count is cleared (e.g., set to zero). If the computer 100 booted from RW_Section B in step 825 as part of a two-stage update process, then the computer 100 successfully booted new firmware in RW_Section B, and the boot count is cleared in step 850. In this case, the new writable firmware may be written to RW_Section A in step 840 to complete the two-stage update process.

FIG. 9 shows a method 900 for updating firmware according to an aspect of the subject technology. The method 900 may be performed when the computer 100 determines that a firmware update is available (e.g., new firmware is available from the storage device 130 or other memory or from a network).

In step 910, a determination is made whether the computer has active developer firmware. If the computer has active developer firmware, then the method 900 is done. This is because, in the developer mode, the user may be responsible for manually updating firmware.

If the computer does not have active developer firmware, then the method 900 proceeds to step 920. In step 920, a determination is made whether the write-protected firmware 222 needs to be updated. This determination may be made by comparing version information for the write-protected firmware 222 currently in the non-volatile memory 115 with version information for available write-protected firmware (e.g., available from the storage device 130 or other memory or available from a network). If write protection is enabled on the non-volatile memory 115 (e.g., for a computer shipped from the manufacturer), then step 920 may be skipped and the method 900 may proceed immediately to step 930.

If the write-protected firmware needs to be updated, then the update count is set to a non-zero value in step 925 so that the write-protected firmware is updated when method 700 is performed at the next startup. After the update count is set, the method 900 is done. Thus, method 900 allows the write-protected firmware to be updated during manufacturing or internal development at the manufacturer. A final version of the write-protected firmware may be locked in the computer before shipment of the computer from the manufacturer by enabling write protection of the non-volatile memory 115.

If the write-protected firmware does not need to be updated, then the method 900 proceeds to step 930.

In step 930, a determination is made whether the computer 100 booted from RW_Section A. If the computer 100 did not boot from RW_Section A (i.e., booted from RW_Section B), then the method 900 is done. This may occur, for example, when the writable firmware in RW_Section A is corrupted, leaving the non-volatile memory 115 within only one good copy of writable firmware in RW_Section B.

If the computer 100 booted from RW_Section A, then the method 900 proceeds to step 950. In step 950, the new version of the writable firmware is written to RW_Section B. In step 960, the boot count is set to a non-zero value so that the boot stub 224 attempts to boot the computer 100 using the new writable firmware in RW_Section B on the next boot cycle. The non-zero value may be selected based on a desired number of boot attempts using the new writable firmware in RW_Section B.

In step 970, a determination is made whether the firmware in the embedded controller 510 needs to be updated. If the firmware in the embedded controller 510 does not needs to updated, then the method 900 is done.

If the firmware in the embedded controller 510 needs to be updated, then the update count is set to a non-zero value in step 975 so that the firmware in the embedded controller 510 is updated when method 700 is performed at the next startup. The non-zero value may be selected based on a desired number of update attempts. After the update count is set, the method 900 is done.

For a computer that does not have developer mode, step 910 may be omitted. Also, after the computer is shipped from the manufacturer with write protection enabled, steps 920 and 925 may be omitted.

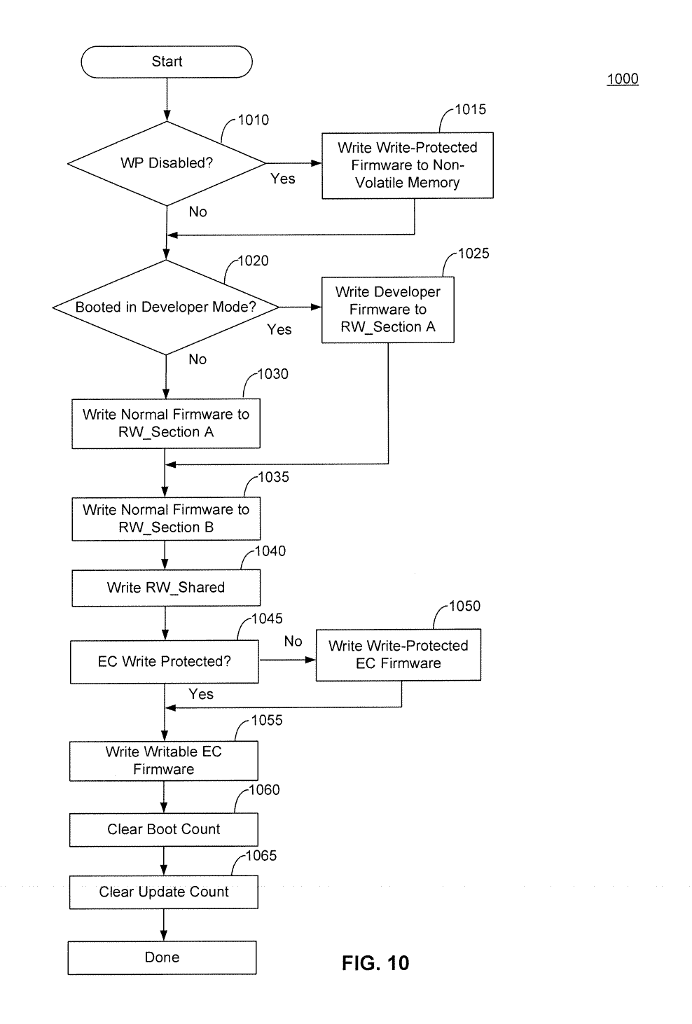

FIG. 10 shows a method 1000 for recovering the computer 100 according to an aspect of the subject technology. Recovery may be performed using an image stored on the external storage device 167, the internal storage device 130 or other memory. The image may include a copy of write-protected firmware, normal firmware, writable shared data, write-protected EC firmware and/or writable EC firmware. The image may also include a copy of developer firmware.

In step 1010, a determination is made whether write-protection is disabled on the non-volatile memory 115. If write-protection is disabled, then the method proceeds to step 1015. In step 1015, write-protected firmware from the image is written to the non-volatile memory 115. After the write-protected firmware is recovered, the method 1000 proceeds to step 1020.

If write-protection is enabled on the non-volatile memory 115, then the method 1000 proceeds directly to step 1020. For example, write-protection may be enabled before the computer 100 is shipped from the manufacturer.

In step 1020, a determination is made whether the computer 100 booted in developer mode. If the computer 100 booted in developer mode, then developer firmware from the image is written to RW_Section A in step 1025. Step 1025 may be performed when the image includes a new version of developer firmware, the user receives an update message in developer mode notifying the user of the new developer firmware, and the user enters a command from the root shell mode to update the developer firmware. In this case, the developer firmware may be updated in step 1025.

In one aspect, step 1025 may be performed when a developer-built recovery image including developer firmware is present in the storage device 130 or other memory. In this aspect, a determination may be made in step 1020 whether the developer-built recovery image is present in the storage device 130 or other memory. If the developer-built recovery image is present, then the method 1000 may proceed to step 1025, in which the developer firmware from the developer-built recovery image is written to RW_Section A.

If the computer 100 did not boot in developer mode and/or a developer-built recovery image is not present, then normal firmware from the image is written to RW_Section A in step 1030. This may occur, for example, when the computer is booted using the recovery firmware 226 in the normal mode.

In step 1035, normal firmware from the image is written to RW_Section B.

In step 1040, writable shared data is written to the non-volatile memory 115 from the image. As discussed above, the writable shared data may include memory timing information for the system memory 120 and/or other memory.

In step 1045, a determination is made whether the EC memory is write protected. If the EC memory is not write protected, then write-protected EC firmware is written to the EC memory from the image in step 1050. After the write-protected EC firmware is recovered, the method 1000 proceeds to step 1055.

If the EC is write protected, then the method proceeds directly to step 1055.

In step 1055, writable EC firmware is written to the EC memory from the image. In step 1060, the boot count is cleared and, in step 1065, the update count is cleared.

For a computer that does not have developer mode, step 1020 and 1025 may be omitted. Also, after the computer is shipped from the manufacturer with write protection enabled on both the non-volatile memory 115 and the EC memory 520, steps 1010, 1015, 1045 and 1050 may be omitted.

Many of the above-described features and applications may be implemented as a set of machine-readable instructions stored on a computer readable storage medium (also referred to as computer readable medium). When these instructions are executed by one or more processing unit(s) (e.g., one or more processors, cores of processors, or other processing units), they cause the processing unit(s) to perform the actions indicated in the instructions. Examples of computer readable media include, but are not limited to, CD-ROMs, flash drives, RAM chips, hard drives, EPROMs, etc. The computer readable media does not include carrier waves and electronic signals passing wirelessly or over wired connections.

In this disclosure, the term “software” and “program” is meant to include firmware or applications stored in a memory, which can be executed by a processor. Also, in some implementations, multiple software aspects can be implemented as sub-parts of a larger program while remaining distinct software aspects. In some implementations, multiple software aspects can also be implemented as separate programs. Finally, any combination of separate programs that together implement a software aspect described here is within the scope of the disclosure. In some implementations, the software programs, when installed to operate on one or more electronic systems, define one or more specific machine implementations that execute and perform the operations of the software programs.

A computer program (also known as a program, software, software application, script, or code) can be written in any form of programming language, including compiled or interpreted languages, declarative or procedural languages, and it can be deployed in any form, including as a stand alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The functions described above can be implemented in digital electronic circuitry, in computer software, firmware or hardware. The techniques can be implemented using one or more computer program products. Programmable processors and computers can be included in or packaged as mobile devices. The processes and logic flows can be performed by one or more programmable processors and by one or more programmable logic circuitry. General and special purpose computers and storage devices can be interconnected through communication networks.

Some implementations include electronic components, such as microprocessors, storage and memory that store computer program instructions in a machine-readable or computer-readable medium (alternatively referred to as computer-readable storage media, machine-readable media, or machine-readable storage media). Some examples of such computer-readable media include RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic and/or solid state hard drives, read-only and recordable Blu-Ray® discs, ultra density optical discs, any other optical or magnetic media, and floppy disks. The computer-readable media can store a computer program that is executable by at least one processing unit and includes sets of instructions for performing various operations. Examples of computer programs or computer code include machine code, such as is produced by a compiler, and files including higher-level code that are executed by a computer, an electronic component, or a microprocessor using an interpreter.

While the above discussion primarily refers to microprocessor or multi-core processors that execute software, some implementations are performed by one or more integrated circuits, such as application specific integrated circuits (ASICs) or field programmable gate arrays (FPGAs). In some implementations, such integrated circuits execute instructions that are stored on the circuit itself.

As used in this specification and any claims of this application, the terms “computer”, “processor”, and “memory” all refer to electronic or other technological devices. These terms exclude people or groups of people. For the purposes of the specification, the terms display or displaying means displaying on an electronic device. As used in this specification and any claims of this application, the terms “computer readable medium” and “computer readable media” are entirely restricted to tangible, physical objects that store information in a form that is readable by a computer. These terms exclude any wireless signals, wired download signals, and any other ephemeral signals.

It is understood that any specific order or hierarchy of steps in the processes disclosed is an illustration of exemplary approaches. Based upon design preferences, it is understood that the specific order or hierarchy of steps in the processes may be rearranged, or that all illustrated steps be performed. Some of the steps may be performed simultaneously. For example, in certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Unless specifically stated otherwise, the term “some” refers to one or more.

A phrase such as an “aspect” does not imply that such aspect is essential to the subject technology or that such aspect applies to all configurations of the subject technology. A disclosure relating to an aspect may apply to all configurations, or one or more configurations. A phrase such as an aspect may refer to one or more aspects and vice versa. A phrase such as a “configuration” does not imply that such configuration is essential to the subject technology or that such configuration applies to all configurations of the subject technology. A disclosure relating to a configuration may apply to all configurations, or one or more configurations. A phrase such as a configuration may refer to one or more configurations and vice versa.

The word “exemplary” is used herein to mean “serving as an example or illustration.” Any aspect or design described herein as “exemplary” is not necessarily to be construed as preferred or advantageous over other aspects or designs.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A computer-implemented method for updating firmware in a computer, the method comprising:
writing new firmware to a non-volatile memory of the computer;
setting a boot count to a non-zero value;
a) decrementing the boot count;
b) attempting to boot the computer using the new firmware in the non-volatile memory;
if the computer fails to boot using the new firmware and the boot count is greater than zero, then repeating steps a) and b).

2. The method of claim 1, further comprising:
if the computer fails to successfully boot using the new firmware and the boot count is zero, then attempting to boot the computer using old firmware in the non-volatile memory.

3. The method of claim 1, wherein decrementing the boot count comprises decrementing the boot count by one.

4. The method of claim 1, wherein the non-volatile memory includes a first section and a second section, and the new firmware is written to the second section and old firmware resides in the first section, the method further comprising:
if the computer successfully boots using the new firmware, then performing the steps of:
erasing the old firmware from the first section of the non-volatile memory; and
writing a copy of the new firmware to the first section of the non-volatile memory.

5. The method of claim 4, further comprising:
if the computer fails to successfully boot using the new firmware and the boot count is zero, then performing the steps of:
erasing the new firmware from the second section of the non-volatile memory; and
writing a copy of the old firmware to the second section of the non-volatile memory.

6. The method of claim 5, further comprising:
when the boot count is zero on a subsequent boot cycle, then attempting to boot the computer using the new firmware in the first section of the non-volatile memory.

7. A machine-readable medium comprising instructions stored therein, which when executed by a machine, cause the machine to perform operations for updating firmware in a computer, the operations comprising:
writing new firmware to a non-volatile memory of the computer;
setting a boot count to a non-zero value;
a) decrementing the boot count;
b) attempting to boot the computer using the new firmware in the non-volatile memory;
if the computer fails to boot using the new firmware and the boot count is greater than zero, then repeating steps a) and b); and
if the computer fails to successfully boot using the new firmware and the boot count is zero, then attempting to boot the computer using old firmware in the non-volatile memory.

8. The machine-readable medium of claim 7, wherein decrementing the boot count comprises decrementing the boot count by one.

9. The machine-readable medium of claim 7, wherein the operations further comprise, if the computer successfully boots using the new firmware and the boot count is greater than zero, then clearing the boot count.

10. The machine-readable medium of claim 7, wherein the non-volatile memory includes a first section and a second section, and the new firmware is written to the second section and the old firmware resides in the first section, and the operations further comprise:
if the computer successfully boots using the new firmware, then performing the steps of:
erasing the old firmware from the first section of the non-volatile memory; and
writing a copy of the new firmware to the first section of the non-volatile memory.

11. The machine-readable medium of claim 10, wherein the operations further comprise:
if the computer fails to successfully boot using the new firmware and the boot count is zero, then performing the steps of:
erasing the new firmware from the second section of the non-volatile memory; and
writing a copy of the old firmware to the second section of the non-volatile memory.

12. The machine-readable medium of claim 11, wherein the operations further comprise:
when the boot count is zero on a subsequent boot cycle, then attempting to boot the computer using the new firmware in the first section of the non-volatile memory.

13. A system for updating firmware in a computer, comprising:
one or more processors; and
a machine-readable medium comprising instructions stored therein, which when executed by the one or more processors, cause the one or more processors to perform operations comprising:
setting an update count to a non-zero value;
after the computer is rebooted, performing the steps of:
a) decrementing the update count;
b) attempting to write new firmware to a non-volatile memory of the computer;
if the computer fails to successfully write the new firmware and the update count is greater than zero, then repeating steps a) and b); and
if the computer successfully writes the new firmware, then rebooting the computer using the new firmware.

14. The system of claim 13, wherein steps a) and b) are performed during startup of the computer.

15. The system of claim 14, wherein the operations further comprise:
if the computer successfully writes the new firmware, then clearing the update count.

16. The system of claim 13, wherein the new firmware comprises embedded controller firmware, and the non-volatile memory comprises a memory of an embedded controller.

17. The system of claim 16, wherein the embedded controller firmware is configured to control at least one of battery charging, a keyboard, and power to devices in the computer.

18. The system of claim 13, wherein the operations further comprise:
determining whether write protection for a portion of the non-volatile memory is disabled; and
determining whether old firmware in the non-volatile memory matches firmware in another memory;
wherein the step of setting the update count to the value greater than on is performed when the write protection is disabled and the old firmware in the non-volatile memory does not match the firmware in the other memory, and wherein the new firmware comprises the firmware in the other memory.
